(19) United States
(12) Patent Application Publication
(10) Pub. No.: US 2004/0185388 A1
(43) Pub. Date: Sep. 23, 2004

(54) Printed circuit board, method for producing same, and ink therefor

(76) Inventor: Hiroyuki Hirai, Kanagawa-ken (JP)

Correspondence Address: BIRCH STEWART KOLASCH & BIRCH, PO BOX 747, FALLS CHURCH, VA, 22040-0747, US

(21) Appl. No.: 10/765,099

(22) Filed: Jan. 28, 2004

(30) Foreign Application Priority Data
Jan. 29, 2003 (JP) 2003-21009

(51) Int. Cl. C09D 11/00; G03C 5/00

(52) U.S. Cl. 430/322; 106/31.13

(57) ABSTRACT

A printed circuit board is produced by drawing a pattern on a substrate by an ink comprising a dispersion of fine particles of a metal oxide or hydroxide; and reducing at least part of the fine particles of a metal oxide or hydroxide to a metal to form a conductive pattern.

### FIELD OF THE INVENTION

The present invention relates to a printed circuit board, particularly a printed circuit board having a circuit formed on demand, a method for producing a printed circuit board having a dense circuit with ease, and an ink therefor.

### BACKGROUND OF THE INVENTION

Known as methods for forming a conductive pattern on a substrate are (i) a method in which a conductive film of silver, copper, etc. is formed on a substrate by sputtering, vacuum deposition, electroless plating, bonding of a metal foil, etc. and etched to a desired pattern by photolithography; (ii) a method in which a mask is used in electroless plating, vacuum deposition, etc. to form a conductive pattern; (iii) a method in which a pattern is drawn with a solder or a conductive paste on a substrate; (iv) a method in which an anisotropic conductive film is formed and attached to a substrate in a desired pattern under pressure; etc. However, it is difficult to rapidly form a fine conductive pattern on a substrate by these methods.

Known other than the above methods is a method in which a silver ink is ejected by an inkjet apparatus, a dispenser, etc. to form a conductive pattern of silver, as described in JP 2002-299833 A, etc. However, because metal particles as small as several tens of nanometers or less have large surface areas, they are susceptible to oxidation, resulting in unneglectably increased resistance when formed to conductive patterns. This is particularly notable on nanoparticles of metals with lower standard electrode potentials, such as copper and tin, making it disadvantageously difficult to store and handle the ink.

Further, JP 59-36993 A discloses a method of forming an insulating material such as Cu₂O and a mixture of Cu₂O and SiO or SiO₂ into a film by a gas phase method such as sputtering, ion plating and CVD, and converting part of the film into a metal by selective energy irradiation to form a conductive pattern. Though this method is suitable for forming a multilayer circuit structure because it can form a conductive pattern with a flat surface, it is disadvantageous in requiring much time for film formation and not adaptable for on-demand film formation.

In addition, JP 5-37126 A discloses a method of forming a metal oxide-based layer on a substrate and reducing the metal oxide to a metal by light or heat to form a circuit pattern. In this method, fine carbon particles and a hydrogen gas are used as reducing agents, which are applied to the entire surface of the metal oxide-based layer. Accordingly, this method is disadvantageous in that a high-accuracy conductive pattern cannot be obtained without difficulty because of the diffusion of light or heat.

### OBJECT OF THE INVENTION

Accordingly, an object of the present invention is to provide a high-accuracy, on-demand printed circuit board that can have a multilayer circuit structure.

Another object of the present invention is to provide a method for producing a printed circuit board with a fine conductive pattern easily and rapidly.

A further object of the present invention is to provide an ink for producing a printed circuit board, which can form a fine conductive pattern easily and rapidly.

### SUMMARY OF THE INVENTION

The first printed circuit board-producing ink of the present invention comprises a dispersion of fine particles of a metal oxide or hydroxide, at least part of the fine particles of a metal oxide or hydroxide being reduced to a metal by energy irradiation.

In the first printed circuit board-producing ink, the dispersion preferably comprises a reducing agent that has substantially no reducing activity to the fine particles of a metal oxide or hydroxide at room temperature but can exhibit the reducing activity by energy irradiation.

The first method of the present invention for producing a printed circuit board comprises the steps of drawing a conductive pattern on a substrate by an ink comprising a dispersion of fine particles of a metal oxide or hydroxide; and reducing the fine particles of a metal oxide or hydroxide to a metal at least partially to form a conductive pattern.

The second printed circuit board-producing ink has at least two liquid parts comprising a dispersion of fine particles of a metal oxide or hydroxide, and a reducing agent having a reducing activity to the fine particles of a metal oxide or hydroxide or its solution, wherein by mixing the liquid parts, at least part of the fine particles of a metal oxide or hydroxide are reduced to a metal.

The second method of the present invention for producing a printed circuit board comprises the steps of drawing a pattern on a substrate by an ink having at least two liquid parts comprising a dispersion of fine particles of a metal oxide or hydroxide, and a reducing agent having a reducing activity to the fine particles of a metal oxide or hydroxide or its solution; and reducing at least part of the fine particles of a metal oxide or hydroxide to a metal to form a conductive pattern.

The reducing agent is preferably at least one compound selected from the group consisting of organic reducing agents, hydrazine and hydroxylamine. The organic reducing agent is preferably at least one organic compound selected from the group consisting of hydrazine derivatives, hydroxylamine derivatives, alkanolamines, diols, and compounds represented by the general formula of X-(A═B)ₙ-Y, wherein each of A and B represents a carbon or nitrogen atom, each of X and Y represents an atomic group having an atom with a lone electron pair bonded to A or B, and n represents 0 to 3.

In the first and second inks, a metal constituting the fine particles of a metal oxide or hydroxide is preferably at least one selected from the group consisting of Au, Ag, Cu, Pt, Pd, In, Ga, Sn, Ge, Sb, Pb, Zn, Bi, Fe, Ni and Co. The metal is more preferably Ag or Cu.

Each of the first and second inks preferably comprises a base or a base precursor. It preferably comprises an adsorbent, a surfactant and/or a hydrophilic polymer.

In the first and second methods, the pattern is drawn preferably by an inkjet printer or a dispenser. The pattern is preferably drawn by the ink according to a pattern information stored in a computer. Energy irradiation is preferably conducted in the process of forming the conductive pattern. The energy irradiation is preferably conducted by laser beams, electron beams, ion beams, or heat rays. The formation of the conductive pattern is preferably conducted in an inert gas.

The printed circuit board of the present invention is produced by the first or second method.

### DETAILED DESCRIPTION OF THE PREFERRED EMBODIMENTS

The first printed circuit board of the present invention comprises a conductive pattern formed by applying a dispersion of fine particles of a metal oxide or hydroxide in a pattern to a substrate, and reducing at least part of the fine metal oxide or hydroxide particles to a metal by energy irradiation.

The second printed circuit board of the present invention comprises a conductive pattern formed by applying a dispersion comprising fine particles of a metal oxide or hydroxide and a reducing agent that has substantially no reducing activity to the fine metal oxide or hydroxide particles at room temperature but can exhibit such reducing activity by energy irradiation in a pattern to a substrate, and reducing at least part of the fine metal oxide or hydroxide particles by energy irradiation.

The third printed circuit board of the present invention comprises a conductive pattern formed by (a) separately preparing at least two liquid parts comprising a dispersion of fine particles of a metal oxide or hydroxide, and a reducing agent having a reducing activity to the fine metal oxide or hydroxide particles or its solution; (b) mixing the liquid parts immediately before use and applying the mixed liquid onto a substrate in a pattern, or applying the liquid parts separately onto the substrate such that they are mixed with each other on the substrate; and then (c) reducing at least part of the fine metal oxide or hydroxide particles by energy irradiation to a metal.

The first method of the present invention for producing a printed circuit board comprises the steps of (a) applying a dispersion of fine particles of a metal oxide or hydroxide in a pattern onto a substrate; and (b) reducing at least part of the fine metal oxide or hydroxide particles by energy irradiation to a metal, thereby forming a conductive pattern.

The second method of the present invention for producing a printed circuit board comprises the steps of (a) applying a dispersion comprising fine particles of a metal oxide or hydroxide, and a reducing agent that has substantially no reducing activity to the fine metal oxide or hydroxide particles at room temperature but can exhibit such reducing activity by energy irradiation in a pattern onto a substrate; and (b) reducing at least part of the fine metal oxide or hydroxide particles by energy irradiation to a metal, thereby forming a conductive pattern.

The third method of the present invention for producing a printed circuit board comprises the steps of (a) separately preparing at least two liquid parts comprising a dispersion of fine particles of a metal oxide or hydroxide, and a reducing agent having a reducing activity to the fine metal oxide or hydroxide particles or its solution; (b) mixing the liquid parts immediately before use and applying the mixed liquid onto a substrate in a pattern, or applying the liquid parts separately onto the substrate such that they are mixed with each other on the substrate; and then (c) reducing at least part of the fine metal oxide or hydroxide particles by energy irradiation to a metal, thereby forming a conductive pattern.

In the printed circuit boards and their production methods of the present invention, the following conditions are preferably met.

(1) The dispersion comprising fine metal oxide or hydroxide particles or another liquid (a reducing agent or its solution) comprises a base or a base precursor.

(2) The metal constituting the metal oxide or hydroxide is at least one selected from the group consisting of Au, Ag, Cu, Pt, Pd, In, Ga, Sn, Ge, Sb, Pb, Zn, Bi, Fe, Ni and Co.

(3) The metal constituting the metal oxide or hydroxide is Ag or Cu.

(4) The reducing agent is at lest one compound selected from the group consisting of organic reducing agents, hydrazine and hydroxylamine.

(5) The organic reducing agent is an organic compound selected from the group consisting of hydrazine derivatives, hydroxylamine derivatives, amino-alcohols, diols, and compounds represented by the general formula of X-(A═B)ₙ-Y, wherein each of A and B represents a carbon or nitrogen atom, each of X and Y represents an atomic group having an atom with a lone electron pair bonding to A or B, and n represents 0 to 3.

(6) Irradiated energy is laser beams, electron beams, ion beams or heat rays.

In the methods of the present invention for producing a printed circuit board, the following conditions are preferably met.

(7) The conductive pattern is drawn by the ink according to a pattern information stored in a computer.

(8) The conductive pattern is drawn by inputting pattern information into a computer, ejecting an ink in a pattern onto a substrate according to the pattern information, and then irradiating energy to the resultant ink layer.

(9) All processes from the mixing of the dispersion and the reducing agent or its solution to the ejection and drawing of the dispersion, etc. onto a substrate, drying and the formation of the conductive pattern are carried out in an inert gas.

The printed circuit board-producing ink of the present invention may be (a) a dispersion comprising at least fine particles of a metal oxide or hydroxide; (a) at least two liquid parts comprising a dispersion of fine particles of a metal oxide or hydroxide and a reducing agent, or (a) at least 2 parts comprising a dispersion of fine particles of a metal oxide or hydroxide and a solution of a base or a base precursor.

When energy is irradiated onto the ink of the present invention drawn on the substrate by technologies such as an inkjet printer and dispenser, fine metal oxide or hydroxide particles are at least partly reduced to form a conductive metal pattern easily and rapidly on an ondemand basis. Even a mild reducing agent stable at room temperature, which hardly reduces a metal oxide or hydroxide at room temperature, has reducing activity increased by energy irradiation, it is preferable to use such reducing agent in the ink. With energy beams narrowed in diameter, an insulating layer of fine metal oxide or hydroxide particles is turned into a finer conductive pattern. Thus, a high-accuracy, high-density conductive pattern can be formed on a flat insulating surface, making it possible to produce a multilayer circuit pattern. Energy irradiation may be carried out in a pattern-forming manner on an ink layer uniformly formed on a substrate, or uniformly on an ink pattern formed on a substrate. Other portions than the conductive pattern on the substrate may be filled with another ink of an insulating material to have a flat surface.

The present invention will be explained in detail below.

[1] Dispersion of Fine Metal Oxide or Hydroxide Particles

(A) Composition and Size of Fine Metal Oxide or Hydroxide Particles

The fine metal oxide or hydroxide particles used in the present invention may comprise a metal such as Au, Ag, Cu, Pt, Pd, In, Ga, Sn, Ge, Sb, Pb, Zn, Bi, Fe, Ni, Co, Mn, Tl, Cr, V, Ru, Rh, Ir and Al. Preferable among these metal oxides or hydroxides is an oxide of Au, Ag, Cu, Pt, Pd, In, Ga, Sn, Ge, Sb, Pb, Zn, Bi, Fe, Ni or Co. The oxide of Ag or Cu such as Ag₂O or Cu₂O is particularly preferable because it can be easily reduced to generate a relatively stable metal. The average crystallite (grain) size of the fine particles is 1 to 100 nm, preferably 1 to 50 nm.

(B) Preparation Method

A dispersion of the fine metal oxide or hydroxide particles may be prepared by neutralizing a solution of a metal salt such as a chloride, a bromide, a sulfate, a nitrate or an organic salt of the above metal with a basic solution; by hydrolyzing a metal alkoxide; or by adding a reducing agent to a solution of a high-valent metal salt to reduce the salt into a low-valent metal oxide or hydroxide; etc. Examples of organic acids for the organic salts include formic acid, acetic acid, propionic acid, butyric acid, isobutyric acid, 2-ethylbutyric acid, pivalic acid, valeric acid, isovaleric acid, propiolic acid, lactic acid, caproic acid, caprylic acid, capric acid, benzoic acid, phthalic acid, salicylic acid, acrylic acid, methacrylic acid, ethylmethylacetic acid, allylacetic acid, and acetoacetic acid.

The fine metal oxide or hydroxide particles may be surface-modified with an adsorbent, a surfactant and/or a hydrophilic polymer adsorbed thereonto, to stabilize the dispersion if necessary.

The dispersion may be subjected to centrifugal separation, etc. to precipitate the fine metal oxide or hydroxide particles in the presence of the adsorbent and/or the surfactant, and the fine particles obtained may be washed and redispersed in another dispersion solvent, if necessary. Further, the dispersion may be subjected to a purification or concentration treatment such as desalination.

(a) Adsorbents

Compounds having functional groups such as —SH, —CN, —NH₂, —SO₂OH, —SOOH, —OPO(OH)₂ and —COOH are useful as the adsorbents. Particularly preferred adsorbents include compounds having —SH such as dodecanthiol and L-cysteine, and compounds having —NH₂ such as octylamine, dodecylamine, oleylamine, oleic amide and lauric amide. In a case where the fine particles are in the form of a hydrophilic colloid, the adsorbent preferably has a hydrophilic group such as —SO₃M and —COOM, in which M represents a hydrogen atom, an alkaline metal atom, or an ammonium group.

(b) Surfactants

The surfactants may be anionic surfactants such as sodium bis(2-ethylhexyl)sulfosuccinate and sodium dodecylbenzenesulfonate; nonionic surfactants such as alkyl esters and alkyl phenyl ethers of polyalkyl glycols; or fluorine-containing surfactants; etc.

(c) Hydrophilic Polymers

Polymers such as hydroxyethyl cellulose, polyvinylpyrrolidone, polyvinyl alcohol, and polyethylene glycol may be contained in the colloidal dispersion as the hydrophilic polymers.

(d) Amount

The amount of the adsorbent, the surfactant and/or the hydrophilic polymer added is preferably 0.01 to 2 parts by mass, more preferably 0.1 to 1 parts by mass, per 1 part of the fine metal oxide or hydroxide particles. The fine particles are preferably coated with the adsorbent, the surfactant and/or the hydrophilic polymer at a thickness of 0.1 to 10 nm. The coating need not be uniform and may cover at least part of the fine particles.

The surface modification of the fine particles with an organic compound such as the adsorbent, the surfactant, and the hydrophilic polymer can be confirmed by observing the regularity of distance between the fine particles with a high-resolution TEM such as FE-TEM, or by a chemical analysis.

(e) Solvents

Examples of solvents for the dispersion of the fine metal oxide or hydroxide particles (and for the ink hereinafter described) include (1) esters such as butyl acetate and cellosolve acetate; (2) ketones such as methyl ethyl ketone, cyclohexanone, methyl isobutyl ketone and acetylacetone; (3) chlorinated hydrocarbons such as dichloromethane, 1,2-dichloroethane and chloroform; (4) amides such as dimethylformamide; (5) aliphatic hydrocarbons such as cyclohexane, heptane, octane, isooctane and decane; (6) aromatic hydrocarbons such as toluene and xylene; (7) ethers such as tetrahydrofuran, ethyl ether and dioxane; (8) alcohols such as ethanol, n-propanol, isopropanol, n-butanol, diacetone alcohol, ethylene glycol, 2,5-hexanediol, 1,4-butanediol, cyclohexanol, cyclopentanol and cyclohexenol; (9) fluorine-containing solvents such as 2,2,3,3-tetrafluoropropanol; (10) glycol ethers such as ethylene glycol monomethyl ether, ethylene glycol monoethyl ether and propylene glycol monomethyl ether; (11) alkylaminoalcohols such as 2-dimethylaminoethanol, 2-diethylaminoethanol, 2-dimethylaminoisopropanol, 3-diethylamino-1-propanol, 2-dimethylamino-2-methyl-1-propanol, 2-methylaminoethanol, and 4-dimethylamino-1-butanol; (12) carboxylic acids such as butyric acid, isobutyric acid, 2-ethylbutyric acid, pivalic acid, valeric acid, propionic acid, lactic acid, acrylic acid, methacrylic acid, propiolic acid, ethylmethylacetic acid and allylacetic acid; (13) amines such as diethylenetriamine and ethylenediamine; and (14) water.

These solvents may be used alone or in combination depending on the dispersion stability of the fine particles, the solubility and oxidation stability of the reducing agent used, the viscosity of the dispersion, etc. It is preferable to select a solvent excellent in the dispersibility of the fine particles and the solubility of the reducing agent.

(C) Dispersion

The concentration of the fine metal oxide or hydroxide particles in the dispersion is preferably 1 to 80% by mass, more preferably 5 to 70% by mass, on a metal basis. The dispersion may contain one or plural kinds of the fine metal oxide particles and/or the fine hydroxide particles. Further, the metals in the fine particles may have the same or different valences. Inorganic fine particles of SiO, SiO₂, TiO₂, etc., or polymers, which may or may not be fine particles, may be used with the fine metal oxide or hydroxide particles to control the insulation and conductivity of the energy-irradiated portions and the energy-unirradiated portions. Though not particularly restrictive, the fine metal oxide or hydroxide particles in the dispersion generally have such diameters as to form a colloid. Their diameters are preferably 1 to 100 nm, more preferably 1 to 50 nm.

[2] Ink

The above dispersion comprising the fine metal oxide or hydroxide particles may be used as ink without modification. A reducing agent may be added to the dispersion when it is difficult to reduce the metal oxide or hydroxide by energy irradiation.

The reducing agent for reducing the metal oxide or hydroxide may be an inorganic or organic reducing agent. Examples of the inorganic reducing agents include NaBH₄, hydrazine, hydroxylamine, etc. Examples of the organic reducing agents include (i) hydrazine derivatives having a hydrazine group such as phenylhydrazine; (ii) amine compounds such as p-phenylenediamine, ethylenediamine and p-aminophenol; (iii) hydroxylamine derivatives having a substituent bonded to a nitrogen atom, such as an acyl group and an alkoxycarbonyl group; (iv) amino alcohols such as 2-dimethylaminoethanol, 2-diethylaminoethanol, 2-aminoethanol, diethanolamine and 2-amino-2-methyl-1-propanol; (v) diols such as hydroquinone, catechol, 1,4-butanediol and ethylene glycol; (vi) compounds represented by the general formula of X-(A═B)ₙ-Y, wherein each of A and B represents a carbon or nitrogen atom, each of X and Y represents an atomic group having an atom with a lone electron pair bonded to A or B, and n represents 0 to 3; tautomers thereof; compounds which can be thermally converted thereto; etc.

Though these reducing agents may be used alone or in combination, they are preferably appropriately combined because they reduce the metal oxide or hydroxide selectively. The reducing agent may be used as an organic solvent, if necessary.

The compound (vi) represented by the general formula of X-(A═B)ₙ-Y has an atom with a lone electron pair, which is preferably oxygen, nitrogen, sulfur or phosphorus, more preferably oxygen or nitrogen. The atomic groups X and Y having such atoms are preferably OR₁, NR₁R₂, SR₁ or PR₁R₂, wherein R₁ and R₂ represent a hydrogen atom or a substituent, which is preferably an alkyl or acyl group having 1 to 10 carbon atoms, which may be substituted.

n is preferably 0 to 3, more preferably 0 to 2, most preferably 0 to 1. When n is 2 or more, A and B may be different in each repeating unit. A and B, X and A, and Y and B may be bonded to form a ring structure, which is preferably a 5- or 6-membered ring. These ring structures may form a condensed ring preferably having 5 or 6 members.

It is preferable to use a reducing agent having a low electric conductivity after the reduction reaction, specifically an organic reducing agent leaving no metal ions, hydrazine and hydroxylamine. Because the residue of the reducing agent after the reduction reaction has adverse effects on the conductivity of the printed circuit, the reducing agent preferably has little residue. It is thus preferable to use the reducing agent whose residue is volatile or sublimable, or decomposed to become volatile after the reduction reaction.

It is similarly preferable that the reducing agent can reduce the metal oxide or hydroxide in a small amount, and that therefore the reducing agent has a low molecular weight. The molecular weight of the reducing agent is preferably 500 or less, more preferably 300 or less, most preferably 200 or less.

Specific examples of the reducing agents used in the present invention for reducing the metal oxide or hydroxide will be illustrated below without intention of restricting the scope of the invention.

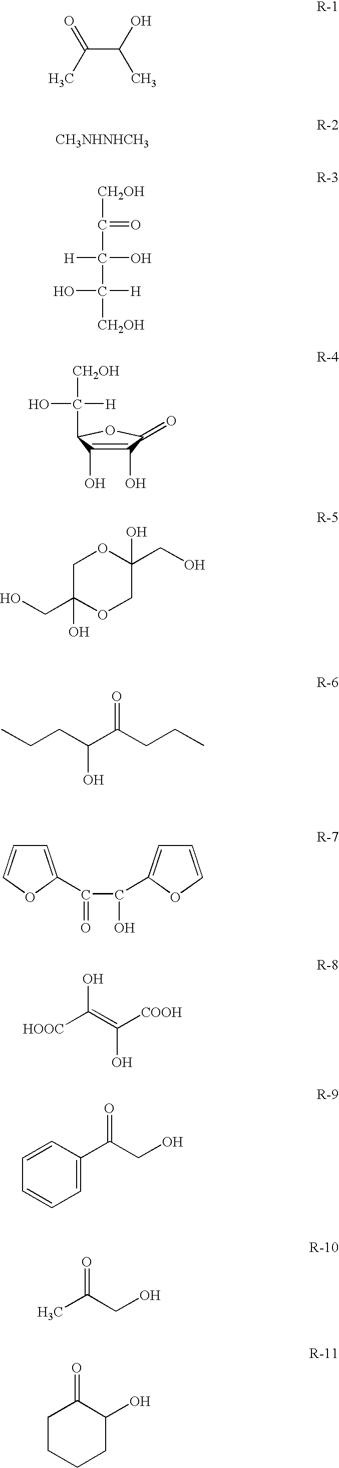

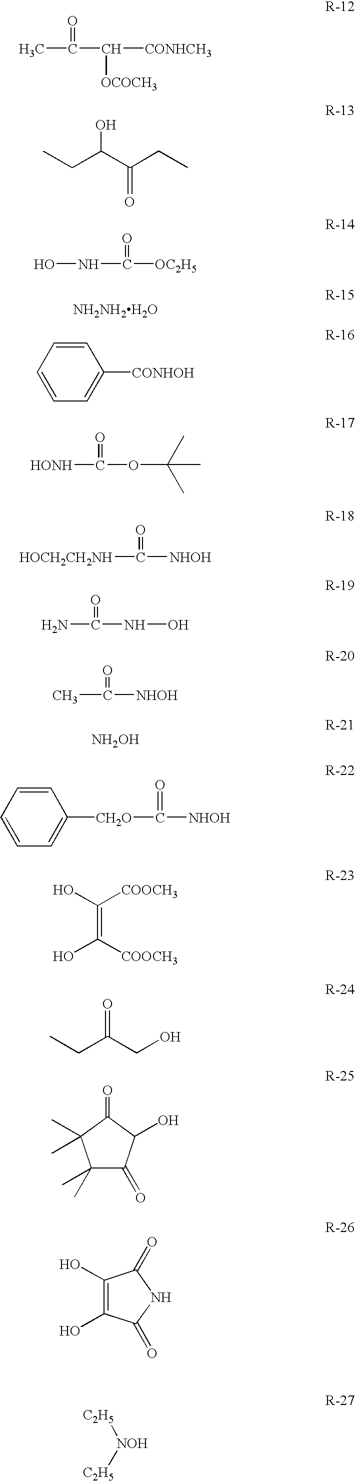

Preferred combinations of the fine metal oxide or hydroxide particles and the reducing agent are (a) a one-can ink comprising a dispersion comprising the fine particles, and the reducing agent that can reduce the metal oxide or hydroxide by energy irradiation though it does not substantially reduce the metal oxide or hydroxide at room temperature; or (b) a two-can ink comprising a dispersion containing the fine metal oxide or hydroxide particles, which may not contain the reducing agent, and a separately prepared solution containing the reducing agent having a reducing activity to the metal oxide or hydroxide, which is high at least by energy irradiation though it may be at any level at room temperature.

In a combination of the metal oxide or hydroxide and the reducing agent, in which the metal oxide or hydroxide is hardly reduced by energy irradiation, or in which energy irradiation causes the reducing agent to exhibit a higher reducing activity, a reduction accelerator such as a base and a base precursor may be added to the dispersion of the metal oxide or hydroxide, or to a different liquid that is the reducing agent or its solution. The base and the base precursor may have reducing activity.

As described above, the reducing agent used in the present invention can preferably rapidly reduce the fine metal oxide or hydroxide particles by energy irradiation, despite a low reduction rate at room temperature. The heating temperature by energy irradiation varies depending on irradiation time, so that it cannot be set without taking the irradiation time into consideration. Taking the heat resistance of the substrate or devices into consideration, the heating temperature by thermal diffusion is preferably about 300° C. or lower, more preferably about 250° C. or lower. Accordingly, the reducing agent preferably shows a sufficient reducing activity to the fine metal oxide or hydroxide particles at a temperature of approximately 300° C. or lower. In a case where a reducing agent having a high reducing activity at room temperature is used for the two-can ink (b), the fine metal oxide or hydroxide particles are reduced immediately after mixing with the reducing agent or its solution, making the subsequent energy irradiation unnecessary.

As described later, because a combination of the dispersion of the fine metal oxide or hydroxide particles and the reducing agent, or a mixture thereof is preferably used as ink for drawing a pattern by an inkjet printer or a dispenser, etc., a solvent may be added to the ink to control its viscosity, if necessary. The solvent for the ink may be the same as for the dispersion.

Additives such as antistatic agents, antioxidants, UV absorbents, plasticizers, carbon nanoparticles, dyes, and thermosetting resins such as thermosetting phenol resins may be added to the dispersion of the fine metal oxide or hydroxide particles and/or the reducing agent or its solution depending on the purposes, if necessary.

When the dispersion of the fine metal oxide or hydroxide particles, the reducing agent or its solution, or a mixture thereof is used as ink for drawing patterns by an inkjet printer or a dispenser, the viscosity of the ink is important. When the ink has too high viscosity, it is difficult to eject the ink from a nozzle. On the other hand, when the ink has too low viscosity, patterns drawn with the ink are likely to be blurred. Specifically, the viscosity of the ink is preferably 1 to 100 cP, particularly 5 to 30 cP. The surface tension of the ink is preferably 25 to 80 mN/m, particularly 30 to 60 mN/m.

[3] Production of Printed Circuit Board

(A) Substrate

Preferred examples of materials for the substrate used in the present invention include (1) glasses such as quartz glass, non-alkali glass crystallized transparent glass, Pyrex glass and sapphire glass; (2) ceramics such as Al₂O₃, MgO, BeO, ZrO₂, Y₂O₃, ThO₂, CaO and GGG (gadolinium gallium garnet); (3) thermoplastic resins such as polycarbonates, acrylic resins such as polymethyl methacrylates, vinyl chloride-based resins such as polyvinyl chlorides and vinyl chloride copolymers, polyarylates, polysulfones, polyethersulfones, polyimides, fluorine resins, phenoxy resins, polyolefin resins, nylons, styrene resins and ABS resins; (4) thermosetting resins such as epoxy resins; (5) metals; etc.

The above substrate materials may be used in combination, if necessary. These substrate materials may be appropriately selected depending on applications, to provide a film-shaped, flexible or rigid substrate. The substrate may be in a shape of disc, card, sheet, etc. The substrate may have a three-dimensional laminate structure. Further, the substrate may have fine pores or grooves with aspect ratios of 1 or more in a portion on which the printed circuit is formed. The dispersion of the fine metal oxide or hydroxide particles, the reducing agent or its solution, or a mixture thereof may be ejected into the fine pores or grooves by an inkjet printer or a dispenser.

A primer layer may be formed on the substrate to increase its surface smoothness and adhesion and to prevent its deterioration. The primer layer is preferably made of a material having excellent adhesion to the substrate and the ink. Examples of such materials include (1) thermoplastic resins such as polymethyl methacrylates, acrylic acid-methacrylic acid copolymers, styrene-maleic anhydride copolymers, polyvinyl alcohols, N-methylol-polyacrylamides, styrene-vinyltoluene copolymers, chlorosulfonated polyethylenes, nitrocelluloses, polyvinyl chlorides, polyvinylidene chlorides, chlorinated polyolefins, polyesters, polyimides, vinyl acetate-vinyl chloride copolymers, ethylene-vinyl acetate copolymers, polyethylenes, polypropylenes and polycarbonates; (2) thermosetting, photo-curable or electron beam-curable resins; (3) coupling agents such as silane coupling agents, titanate coupling agents, germanium coupling agents and aluminum coupling agents; and (4) colloidal silica; etc.

The primer layer may be formed on the substrate by coating a coating liquid of the above material dissolved or dispersed in a suitable solvent. The coating liquid may be applied by a coating method such as a spin-coating method, a dip-coating method, an extrusion-coating method, and a bar-coating method. In general, the dry thickness of the primer layer is preferably 0.001 to 20 μm, more preferably 0.005 to 10 μm.

(B) Drawing with Ink

To draw a pattern with the ink on the substrate, it is preferable to eject ink droplets from a nozzle onto the substrate by an inkjet printer or a dispenser. In the case of mixing two liquids immediately before ejection, they are preferably mixed by a microreactor or a micromixer.

The microreactor and the micromixer are described in detail in JP 2003-193119 A. This microreactor comprises a first channel for a fluid 1 and a second channel for a fluid 2, each fluid flowing substantially in a thin layer to form a contact interface in at least one portion in their flow paths, and each thin flow being as thick as 1 to 500 μm at the contact interface, at which the two fluids are reacted or mixed.

Inkjet printers with various ink-ejecting systems may be used in the present invention. The inkjet printers may be a piezoelectric type, a bubble jet type, an air flow type, a thermal melting ink type, an electrostatic induction type, an acoustic printing type, an electroviscous ink type, a continuous ejection type suitable for mass printing, etc. These inkjet printers may be selected depending on the desired shape and thickness of the pattern, the type of the ink, etc.

The width and pitch of the print pattern can be reduced to approximately several micrometers by controlling the size of ink droplets in the inkjet printer, or by controlling the flow rate of ink droplets in the dispenser. Thus, the inkjet printer and the dispenser can be effectively utilized to form circuit patterns. With an ejecting means of the inkjet printer or the dispenser connected to a computer such as a personal computer, patterns can be drawn on the substrate in response to pattern information stored in the computer. Because the fine metal oxide or hydroxide particles are generally insulating, they may be drawn in a wide pattern on the substrate by the inkjet printer or the dispenser, to selectively irradiate energy onto a narrower region in the pattern to form a fine conductive pattern. In this case, the conductive pattern desirably has substantially the same dry thickness as that of the insulating region. The thickness of the conductive pattern and the insulating region may be selected from a range of 0.1 to 10 μm depending on applications.

As described above, the present invention can form conductive patterns much more easily in a shorter period of time as compared with conventional methods of pattering conductive films with photoresists.

(C) Formation of Conductive Pattern

Energy irradiation means for forming the conductive pattern may be electric furnaces, electromagnetic waves such as microwaves, infrared rays, hot plates, laser beams, electron beams, ion beams, or heat rays, etc. Particularly preferred are the laser beams, the electron beams, the ion beams, and the heat rays, which can heat the applied ink locally or in a fine pattern. The laser beams are most preferable because they can easily be irradiated from a relatively small apparatus.

The wavelength of the laser beams may be properly selected in a range from ultraviolet to infrared as long as they can be absorbed by the fine metal oxide or hydroxide particles, the reducing agent and the solvent, and carbon nanoparticles, dyes, etc. if any. Typical examples of the lasers include semiconductor lasers of AlGaAs, InGaAsP, GaN, etc.; Nd:YAG lasers; excimer lasers of ArF, KrF, XeCl, etc.; dye lasers; solid lasers such as ruby lasers; gas lasers of He—Ne, He—Xe, He—Cd, CO₂, Ar, etc; and free-electron lasers. Surface emission semiconductor lasers and multimode arrays comprising such lasers arranged one- or two-dimensionally may also be used.

Higher harmonics such as second harmonics and third harmonics of these laser beams may be used for the energy irradiation. The laser beams may be irradiated continuously or pulsewise. Depending on the types and amounts of the fine metal oxide or hydroxide particles, the reducing agent, the binder, the solvent, etc., the amount of energy may be determined such that generated metal nanoparticles are melted substantially without ablation.

Among processes from the mixing of the dispersion and the solution to the ejection, drawing and drying of the dispersion, etc. on the substrate and the formation of the conductive pattern, at least the process of forming the conductive pattern is desirably carried out in an inert gas. The inert gas may be nitrogen, helium, neon, argon, etc. The conductive pattern can be efficiently formed in an inert gas without reoxidation of generated metal nanoparticles.

The present invention will be described in more detail below with reference to Examples without intention of restricting the scope of the present invention.

### EXAMPLE 1

50 g of copper (II) acetate monohydrate was dissolved in a mixed solvent of 50 ml of isobutyric acid, 70 ml of 2-ethoxyethanol, and 20 ml of water by heating at 130° C. 1.5 ml of dodecylamine and 45 ml of Compound R-10 were added to the resultant solution to cause their reaction for 1 minute, and cooled to room temperature, to obtain a reddish brown colloidal dispersion. The dispersion was dried and subjected to X-ray diffraction (XRD) measurement. It was thus confirmed that fine Cu₂O particles having an average crystallite size of 14 nm was generated.

Quintuple volume of methanol was added to the colloidal Cu₂O dispersion to precipitate Cu₂O nanoparticles. The supernatant liquid was removed by decantation, and methanol was added to the residue again to wash the Cu₂O nanoparticles. After repeating these processes three times, the Cu₂O nanoparticles were redispersed in a solution of 1 ml of dodecylamine, 35 ml of 2-ethoxyethanol and 15 ml of water, to obtain a 25-%-by-mass dispersion of the fine Cu₂O particles.

The dispersion of the fine Cu₂O particles was ejected by a dispenser onto a polyimide substrate along its 50 μm-deep, 1-mm-wide, fine grooves to a liquid thickness of 70 μm. After drying at 80° C. by a hot plate, the dispersion was irradiated with infrared laser beams of 830 nm at 20 J/cm² in a nitrogen atmosphere, to obtain a copper circuit having a specific resistance of 8 μΩ·cm and a thickness of approximately 4 μm.

### EXAMPLE 2

A copper circuit was produced in the same manner as in Example 1 except that the irradiation of infrared rays of 830 nm was carried out in the air. The resultant irradiated portions had a specific resistance of 20 μΩ·cm.

### EXAMPLE 3

The dispersion of the fine Cu₂O particles and a liquid Compound R-10 in Example 1 were instantaneously mixed at a volume ratio of 10/3 by a microreactor described in JP 2003-193119 A. The resulting mixture was ejected by a dispenser into the fine grooves of the polyimide substrate of Example 1 to a liquid thickness of 100 μm in a nitrogen atmosphere. After drying, 830-nm infrared lasers were irradiated in a nitrogen atmosphere to obtain a copper circuit having a specific resistance of 6 μΩ·cm and a thickness of approximately 4 μm.

### EXAMPLE 4

17 g of silver (I) nitrate was dissolved in a mixed solvent of 25 ml of water and 25 ml of 2-ethoxyethanol, and cooled with ice. 500 ml of a 0.1-N aqueous NaOH solution containing 50% by volume of 2-ethoxyethanol was cooled with ice and added to the resultant silver nitrate solution. Nanoparticles thus obtained were precipitated and washed in the same manner as in Example 1, and redispersed in a mixed solvent of cyclohexanol and 2-ethoxyethanol (volume ratio 50:50), to obtain a 20-%-by-mass dispersion of fine Ag₂O particles having an average crystallite size of 16 nm.

The dispersion of fine Ag₂O particles was ejected onto a polyimide substrate by a piezoelectric inkjet printer at a rate of 50 picometers/droplet to draw a conductive pattern according to pattern information stored in a computer. After drying, the dispersion was irradiated with infrared laser beams in the same manner as in Example 1. As a result, Ag₂O was reduced to conductive Ag.

As is clear from above, precise conductive patterns can be easily formed by using the printed circuit board-producing ink of the present invention comprising fine particles of metal oxide or hydroxide such as Cu₂O and Ag₂O, thereby providing printed circuit boards with precise conductive patterns easily, rapidly and stably.

What is claimed is:

1. A printed circuit board-producing ink comprising a dispersion of fine particles of a metal oxide or hydroxide, at least part of said fine particles of a metal oxide or hydroxide being reduced to a metal by energy irradiation.

2. The printed circuit board-producing ink of claim 1, wherein said dispersion comprises a reducing agent that has substantially no reducing activity to said fine particles of a metal oxide or hydroxide at room temperature but can exhibit said reducing activity by energy irradiation.

3. The printed circuit board-producing ink of claim 2, wherein said reducing agent is at least one compound selected from the group consisting of organic reducing agents, hydrazine and hydroxylamine.

4. The printed circuit board-producing ink of claim 3, wherein said organic reducing agent is at least one organic compound selected from the group consisting of hydrazine derivatives, hydroxylamine derivatives, alkanolamines, diols, and compounds represented by the general formula of X-(A═B)ₙ-Y, wherein each of A and B represents a carbon or nitrogen atom, each of X and Y represents an atomic group having an atom with a lone electron pair bonded to A or B, and n represents 0 to 3.

5. The printed circuit board-producing ink of claim 1, wherein a metal constituting said fine particles of a metal oxide or hydroxide is at least one selected from the group consisting of Au, Ag, Cu, Pt, Pd, In, Ga, Sn, Ge, Sb, Pb, Zn, Bi, Fe, Ni and Co.

6. A method for producing a printed circuit board comprising the steps of drawing a conductive pattern on a substrate by an ink comprising a dispersion of fine particles of a metal oxide or hydroxide; and reducing at least part of said fine particles of a metal oxide or hydroxide to a metal to form a conductive pattern.

7. The method of claim 6, wherein said pattern is drawn by said ink according to a pattern information stored in a computer.

8. The method of claim 6, wherein energy irradiation is conducted in the process of forming said conductive pattern.

9. The method of claim 6, wherein the formation of said conductive pattern is conducted in an inert gas.

10. A printed circuit board produced by the method of claim 6.

11. A printed circuit board-producing ink having at least two liquid parts comprising a dispersion of fine particles of a metal oxide or hydroxide, and a reducing agent having a reducing activity to said fine particles of a metal oxide or hydroxide or its solution, wherein by mixing said liquid parts, at least part of said fine particles of a metal oxide or hydroxide are reduced to a metal.

12. The printed circuit board-producing ink of claim 11, wherein said reducing agent is at least one compound selected from the group consisting of organic reducing agents, hydrazine and hydroxylamine.

13. The printed circuit board-producing ink of claim 12, wherein said organic reducing agent is at least one organic compound selected from the group consisting of hydrazine derivatives, hydroxylamine derivatives, alkanolamines, diols, and compounds represented by the general formula of X-(A═B)ₙ-Y, wherein each of A and B represents a carbon or nitrogen atom, each of X and Y represents an atomic group having an atom with a lone electron pair bonded to A or B, and n represents 0 to 3.

14. The printed circuit board-producing ink of claim 11, wherein a metal constituting said fine particles of a metal oxide or hydroxide is at least one selected from the group consisting of Au, Ag, Cu, Pt, Pd, In, Ga, Sn, Ge, Sb, Pb, Zn, Bi, Fe, Ni and Co.

15. A method for producing a printed circuit board comprising the steps of drawing a pattern on a substrate by an ink having at least two liquid parts comprising a dispersion of fine particles of a metal oxide or hydroxide, and a reducing agent having a reducing activity to said fine particles of a metal oxide or hydroxide or its solution; and reducing at least part of said fine particles of a metal oxide or hydroxide to a metal to form a conductive pattern.

16. The method of claim 15, wherein said pattern is drawn by said ink according to a pattern information stored in a computer.

17. The method of claim 15, wherein energy irradiation is conducted in the process of forming said conductive pattern.

18. The method of claim 15, wherein the formation of said conductive pattern is conducted in an inert gas.

19. A printed circuit board produced by the method of claim 15.
